(19) United States
(12) Patent Application Publication
(10) Pub. No.: US 2014/0067975 A1
(43) Pub. Date: Mar. 6, 2014

(54) PROCESSING MESSAGES

(71) Applicant: International Business Machines Corporation, Armonk, NY (US)

(72) Inventors: Hong Wei Ding, Beijing (CN); Jin Dong, Beijing (CN); Ding Ding Lin, Beijing (CN); Wei Wang, Beijing (CN); Xiao Qing Wang, Beijing (CN); Yong Qing Xue, Beijing (CN)

(73) Assignee: International Business Machines Corporation, Armonk, NY (US)

(21) Appl. No.: 14/014,484

(22) Filed: Aug. 30, 2013

(30) Foreign Application Priority Data
Aug. 31, 2012 (CN) 201210320773.9

(51) Int. Cl. H04L 12/58

(52) U.S. Cl. CPC H04L 51/12
USPC 709/206

(57) ABSTRACT

A message processing method and system. According to embodiments of the present invention, the preference of a user for messages may be determined based on actions of the user regarding those messages. The message is analyzed to determine one or more categories to which content of the messages belongs to. Thus, a matching degree between the user and a corresponding category may be determined or adjusted according to the preference of the user for the messages. Such a matching degree may be then used for filtering an incoming message. According to embodiments of the present invention, for each specific user, the information that a user is not interested in may be filtered in a more accurate and adaptive manner.

### CROSS REFERENCE

This application claims priority under 35 U.S.C. §119 from Chinese Patent Application No. 201210320773.9 filed on Aug. 31, 2012 the entire contents of which are incorporated herein by reference.

### BACKGROUND OF THE INVENTION

The present invention relates to the data processing field, and more specifically, to a method and system for processing messages.

With the constant development of network technology, the amount of information on the network has undergone an explosive growth. Currently network information interaction techniques present information to users in the form of a “push.” For example, microblogging is an emerging network information interaction technique. The term “microblog” used here is a particular type of blog, which allows a user to publish information to other users via the network in short text and/or other forms of media. Microblogs (usually in the form of messages) published by a specific user may be pushed to other users on the network, e.g., “friends” of the specific user or people following the specific user. Microblogging has become a means of information interaction which is widely and frequently used by large numbers of users. Many other network information platforms like traditional blogging, bulletin boards and forums also support the push form to users.

In a network information interaction, an important problem is classification or filtering of information. On an information interactive platform like a microblog, a large quantity of information is usually pushed to users without being classified and filtered. Taking microblogs as an example. all pieces of microblogs published by other users followed by a user or friends are pushed to this user. In consequence, the user is overwhelmed by the large quantity of network information, since he/she might have no interest in some of the information at all. It is to be understood that the fact the user follows a friend does not necessarily indicate he/she is interested in all information published by the friend; perhaps he/she only follows specific categories of messages published by the friend. Therefore, it is necessary to filter and classify network information according to user preferences.

Some methods have been proposed for filtering or classifying network information before pushing the information to users. For example, some websites or information platforms allow users to manually select message categories of interest, such as business, science, sports, life, etc. However, such classification of network information is predetermined by operators, which does not necessarily represent the classification of messages for each specific user. In addition, content of many messages might belong to more than one category. Moreover, such information classification relying on user manual operation is often static and cannot be dynamically updated during usage. Other known algorithms for filtering network information only rely on content of a message itself but does not take into consideration the dynamic actions and preference of a user.

It is to be understood that the above-identified problems are especially apparent when providing network information in the push form. However, a similar problem also exists with other modes of information providing and presenting service; that is, quantities of information are provided to users directly without being classified, thereby causing much inconvenience.

### SUMMARY OF THE INVENTION

In view of the foregoing problems in the prior art, there is a need in the art for a method and system for efficiently processing messages.

One aspect of the present invention is a message processing method that includes: determining a preference of a user for at least one message according to an action of the user regarding the message; determining at least one category to which content of the at least one message belongs; and based on the preference, updating a matching degree between the user and the at least one category for filtering further incoming messages.

Another aspect of the present invention is a message processing system that includes a preference determining module configured to determine the preference of a user for at least one message according to actions of the user regarding the message; a category determining module configured to determine at least one category to which content of the at least message belongs; and a matching degree determining module configured to determine, according to the preference, a matching degree between the user and the at least one category for filtering further incoming message.

As will be clear from the following description, according to embodiments of the present invention, the preference of a user for messages or degree of interest can be determined based on actions or behaviors of the user regarding these messages. One or more categories to which content of the messages belong can be determined by analyzing the messages. A matching degree between the user and a corresponding category can then be determined or updated according to the preference of the user for the messages.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows a block diagram of an exemplary computer system/server 12 which is applicable to implement embodiments of the present invention;

FIG. 2 shows a flowchart of a message processing method 200 according to one exemplary embodiment of the present invention;

FIG. 3 shows a flowchart of a method 300 for filtering messages according to one exemplary embodiment of the present invention; and

FIG. 4 shows a block diagram of a message processing system 400 according to one exemplary embodiment of the present invention.

### DETAILED DESCRIPTION OF PREFERRED EMBODIMENTS

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Generally, according to embodiments of the present invention, a user's preference for messages may be determined based on the user's actions regarding these messages. Moreover, one or more categories to which message content belongs to may be determined by analyzing the message. Thus, the user's matching degree with a corresponding category may be determined or updated according to the user's preference for messages. For any incoming message, first one or more categories to which content of the incoming message belongs may be determined; then, whether to filter the incoming message or provide it to the user for display is determined according to (1) the previously determined matching degree of the user with the category, (2) the similarity between the user and a sender of the incoming message and/or (3) the similarity between the user and an associated user of the sender of the incoming message. By establishing and adjusting the matching degree of the user with different message categories, embodiments of the present invention can filter information of which the user has no interest more accurately, dynamically and adaptively.

It should be noted particularly that information will be mainly described in the form of “messages” in the following description. Messages may include text messages, multimedia messages, rich media messages or any combination thereof. This is only for the consideration and purpose of facilitating description, rather than limiting the scope of the present invention in any form.

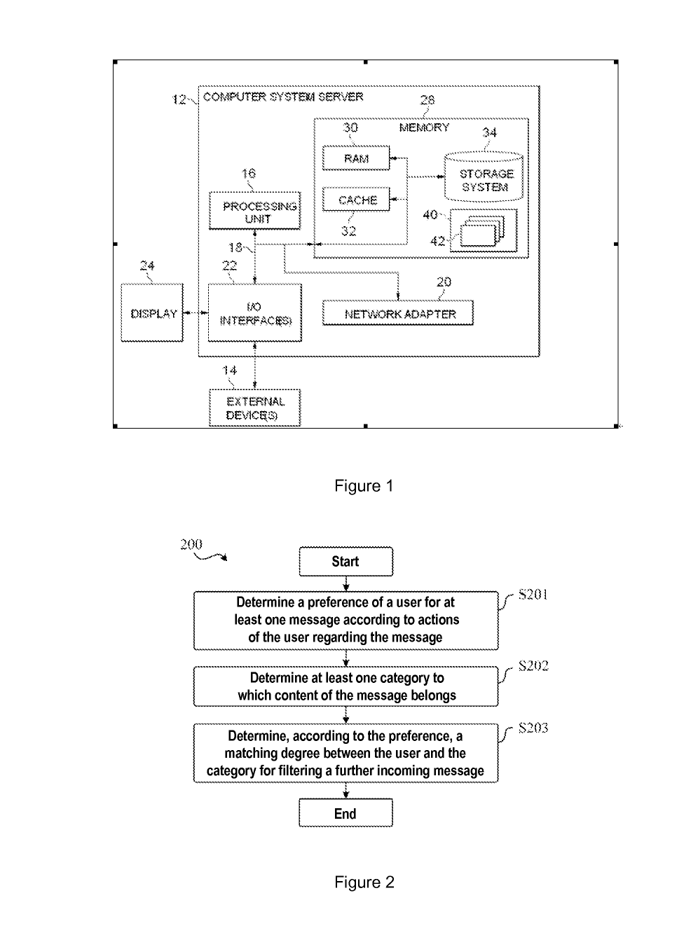

Referring now to FIG. 1, in which an exemplary computer system/server 12 which is applicable to implement embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

With reference now to FIG. 2, a flowchart of a method 200 for processing messages according to one exemplary embodiment of the present invention is shown. The method 200 is primarily for the purpose of determining and adjusting matching degrees of the user with a plurality of predetermined categories, for filtering incoming messages subsequently.

After the method 200 starts, at step S201, preference of the user for at least one message is determined according to actions of the user regarding the message.

The “user” as used herein refers to a user of an information interactive system (a microblog system by way of example) which allows users to communicate with each other by means of network technology. Accordingly, the “message” as used herein refers to a message delivered via the information interaction system between users of the system.

According to embodiments of the present invention, the user's actions regarding a message may be regarded as the user's feedback about the message, and such feedback reflects the user's preference for the message. The term “preference” used here refers to a degree to which the user is interested in a message presented to him/her. Preference may be represented in various manners. For example, preference may be represented in a qualitative manner, e.g., “interested,” “relatively interested,” “less interested,” “least interested,” etc. Alternatively or additionally, preference may also be a quantitative value, for example, represented as a preference score. The scope of the present invention is not limited in this regard.

According to embodiments of the present invention, as an example, the actions of the user regarding messages as collected in step S201 may include at least one of: the user creating the messages; the user browsing the messages; the user forwarding the messages; the user collecting the messages; the user clicking on items representing the messages (e.g., icons or interface controls); and the user deleting the messages, etc. They are merely examples and not intended to limit the scope of the present invention. Any actions of the user regarding messages may be collected at step S201.

It is to be understood that the actions of the user regarding messages can reflect the user's preference for these messages. For example, the user himself/herself creating a new message may indicate, to a certain degree, that the user is interested in such a category of messages. Likewise, the user forwarding or collecting a message may indicate a positive preference for this message. On the contrary, if after receiving a message the user deletes the message without reading, it may indicate that the user is not interested in such a category of messages, i.e., the user has a negative preference for the message.

Consider a specific exemplary embodiment. At step S201, the user's preference for a message may be determined from browsing actions of the user regarding the message. In particular, a time duration for which the user browses a message may be estimated or calculated. For example, for a message like email and so on, the browsing time duration may be estimated from the user opening the message to the user closing the message. For a message like a microblog, which is arranged on the screen and displayed sequentially, the browsing time duration may be estimated from the message entering a display area of the screen to the message leaving the display area. This is merely exemplary. According to different categories of messages and display modes thereof, those skilled in the art would envision various alternative and/or additional manners for estimating a time duration for which the user browses a message. The scope of the present invention is not limited in this regard.

According to embodiments of the present invention, the user's preference for a message may be determined according to the time duration for which the user browses the message. For example, if the user has browsed a message for a short time, it indicates that the user is not interested in the message, i.e., preference tends to be negative. Likewise, if the user has browsed a message for a long time, it indicates that perhaps the user was not reading the message but was distracted by other affairs. Accordingly, in this case it may be inferred that the user's preference for the message tends to be negative as well.

Based on this idea, an upper threshold and a lower threshold of the browsing time may be set. Only if the time duration for which the user browses a message is between the upper threshold and the lower threshold, the preference of the user for the message is regarded positive. That is, the user is relatively interested in the message. On the contrary, if the time duration for which the user browses a message is below the lower threshold or above the upper threshold, the preference of the user for the message is regarded negative.

In particular, according to some embodiments of the present invention, the time threshold associated with a browsed message may be set according to content of the message. For example, the time threshold associated with a message with more content is larger accordingly. In addition, the user may configure the threshold of the browsing time. Moreover, embodiments of the present invention are not limited to setting only two thresholds. Instead, the browsing time may be divided into multiple intervals each representing a different preference degree. It should be further noted that the embodiment of determining user preference according to the browsing time is not necessarily implemented depending on a time threshold, and other embodiments are also applicable.

According to embodiments of the present invention, any one or any combination of multiple actions of the user regarding a message may be considered at step S201. When more than one action is taken into consideration, a different weight may be set for each action so that various actions can reflect different degrees of user preference. Accordingly, at step S201, whether preference of the user for the message tends to be positive or negative may be determined by weighted average, for example.

As described above, preference may be represented in a quantitative and/or qualitative manner. Accordingly, preference of the user for the message as determined at step S201 may be a qualitative description, e.g., “positive,” “negative,” “interested,” “not interested,” etc. Alternatively or additionally, preference determined at step S201 may be a quantitative description. For example, positive values represent different degrees of positive preference, and negative values represent different degrees of negative preference.

Next, the method 200 proceeds to step S202 where at least one category to which content of the message processed at step S201 is determined.

According to embodiments of the present invention, message categories being considered may be predetermined and may be added, modified, updated and/or deleted with time. Depending on specific application scenarios and requirements, predetermined categories may include any appropriate message categories, e.g., “news,” “military,” “sports,” “business,” “entertainment,” etc. The scope of the present invention is not limited in this regard.

According to embodiments of the present invention, a category to which content of the message belongs may be determined by various appropriate technical means that are currently known or to be developed in the future. A kind of feasible embodiment is keyword-based extraction. In these embodiments, at least one keyword may be extracted from a message. Various appropriate techniques may be used in conjunction with embodiments of the present invention, for extracting keywords from a text and/or multimedia message. For example, the following documents provide methods for extracting keywords from textual content: He Xingui, Peng Puyang, “Automatic Extraction and Fuzzy Classification of Keywords for Chinese Text,” Journal of Chinese Information Processing, 1999, 13(1):9-15; Li Sujian, Wang Houfeng, Yu Shiwen, Xin Chengsheng, “Application Research on Maximum Entropy Model for Automatic Keyword Indexing,” 2004, 27(9):1192-1197; Suo Hongguang, Liu Yushu, Cao Shuying, “Method for Keyword Extraction Based on Lexical Chain,” Journal of Chinese Information Processing, 2006, 20(6):27-32. Similarly, techniques for extracting keywords from multimedia content like images and video are also known in the art. The scope of the present invention is not limited in this regard.

According to embodiments of the present invention, mappings may exist between keywords and categories. These mappings may be predefined and updated as the method 200 is implemented. For any message category, whether or not a message belongs to the category may be determined depending on whether a mapping exists between a keyword extracted from the message content and the category. In particular, it is to be understood that content of a message might include keywords associated with a plurality of categories. Accordingly, it can be concluded that the content of the message belongs to the plurality of categories.

The keyword-based embodiment that has been described above is merely exemplary, and all alternative and/or additional embodiments are feasible. For example, a category to which content of a message manually inputted by the user may be prompted via the User Interface (UI). For another example, the user is allowed to select a category to which content of a message belongs, via a control (e.g., the drop-down list, menu, checkbox, etc.) on the User Interface. Other embodiments are also feasible. The scope of the present invention is not limited in this regard.

The method 200 continues proceeding to step S203 where a matching degree of the user with the at least one category determined at step S202 is determined based on the preference determined at step S201 for filtering a subsequent incoming message.

According to embodiments of the present invention, for each user, matching degrees of the user with one or more message categories are maintained. The term “matching degree” as used herein refers to a degree to which the user matches a specific message category. The higher a user's matching degree with a category, the higher the possibility that the user is interested in or follows messages in that category.

According to embodiments of the present invention, matching degrees may be stored in any appropriate manner. For example, matching degrees may be saved in a table structure. Alternatively or additionally, matching degrees may also be saved as a structured file such as the Extensible Markup Language (XML) or an unstructured file. The scope of the present invention is not limited in this regard.

According to embodiments of the present invention, a user's matching degree with each message category may be initially set as a predetermined initial value, zero for example. If the user's preference for the current message as determined at step S201 is positive, then at step S203, the matching degree of the user with the at least one message category determined at step S202 is increased. On the contrary, if the user's preference for the current message as determined at step S201 is negative, then at step S203, the matching degree of the user with the at least one message category determined at step S202 is decreased.

By updating the matching degree at step S203, the user's actions or feedback regarding the message can be collected and learned, and the user's matching degrees with respective message categories can be determined or adjusted in a dynamic manner accordingly. By performing steps S201-S203 to a given number of messages, matching degrees of the user with one or more message categories can be obtained and stored.

The matching degree determined at step S203 will be used for filtering a subsequent incoming message.

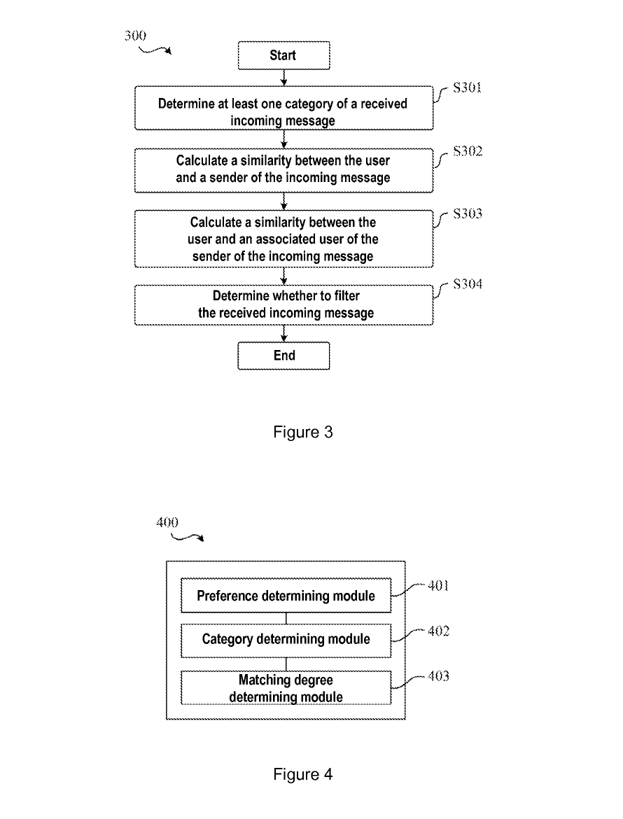

Generally, when a new incoming message is received, a category to which content of the incoming message belongs can be determined. Then, whether to filter the incoming message or provide it to the user for display can be determined at least according to the matching degree of the user with the category. A specific exemplary embodiment will be described below with in conjunction with FIG. 3.

The method 200 ends after step S203.

Those skilled in the art would appreciate that the method 200 is essentially a process of training and learning. By carrying out the method 200, matching degrees of a user with at least some of multiple predetermined message categories may be obtained, thus efficiently classifying messages for the subsequent filtering operation. According to embodiments of the present invention, the method 200 may be implemented within a given period of time. Alternatively, the method 200 may be implemented unremittingly or periodically with the user operation. The scope of the present invention is not limited in this regard.

Now refer to FIG. 3, which shows a flowchart of a method 300 for filtering an incoming message according to a matching degree of the user with a message category.

After the method 300 starts, at least one category to which content of the received incoming message is determined at step S301. According to embodiments of the present invention, the category of the incoming message may be determined in the way as described at step S202 with reference to FIG. 2, which is not detailed here.

Then the method 300 proceeds to step S302 where the similarity between the user and a sender of the incoming message is calculated.

It is to be understood that the sender of the incoming message is also a registered user in the information interactive system. Thus, the sender of the incoming message also has matching degrees with one or more categories which have been determined and stored. According to embodiments of the present invention, the similarity between a target user and the message sender may be calculated according to matching degrees of the user with one or more predetermined message categories and the matching degrees of the sender with the predetermined message categories.

For example, suppose N message categories are considered, they are denoted as c₁, c₂, . . . , c_{N}, wherein N is a natural number. As described above, matching degrees of each user with the N predetermined message categories may be represented quantitatively. Values of matching degrees of the considered target user with the N predetermined message categories are recorded as k₁, k₂, . . . , k_{N}. It is to be understood that at least part of k₁, k₂, . . . , k_{N} have undergone the determination or adjustment of the method 200. Likewise, matching degrees of the sender of the incoming message with the N predetermined message categories are recorded as k₁′, k₂′, . . . , k_{N}′.

According to embodiments of the present invention, (k₁, k₂, . . . , k_{N}) and (k₁′, k₂′, . . . , k_{N}′) may be regarded as vectors, and the similarity S1 between the user and the sender of the incoming message is defined using a distance in the vector space:

$$S 1 = \frac{{k}_{1} {k}_{1}^{′} + {k}_{2} {k}_{2}^{′} + … + {k}_{N} {k}_{N}^{′}}{\sqrt{{k}_{1}^{2} + {k}_{2}^{2} + … + {k}_{N}^{2}} \cdot \sqrt{{k}_{1}^{′ 2} + {k}_{2}^{′ 2} + … + {k}_{N}^{′2 }}} \qquad ( 1 )$$

The similarity S1 between the user and the message sender may be used for determining whether to filter the message, as to be described below with reference to step S304.

It is noted that what has been described above with reference to formula (I) is merely an example of calculating the similarity. Given respective matching degrees (k₁, k₂, . . . , k_{N}) and (k₁′, k₂′, . . . , k_{N}′), those skilled in the art would devise various alternative and/or additional approaches to calculating the similarity between the user and the message sender. The scope of the present invention is not limited in this regard.

Then, the method 300 proceeds to step S303 where the similarity between the user and an associated user of the message sender is calculated.

As described above, the similarity between the user and the sender of the incoming message is calculated at step S302. Alternatively or additionally, other users associated with the sender in the information interactive system may be taken into consideration, so as to further improve the precision of message filtering. The term “associated” used here means that two users are related or connected to each other in any manner in the information interactive system, for example, for a relationship as “friend” or “follow.”

Note in the information interactive system the association between users is hierarchical. For example, if user A and user B are directly connected (for example, having a friend relationship or user A directly follows user B), then the association between user A and user B is one-level. If user C is associated with user B but not with user A, then the association between user A and user C is two-level, and so on and so forth. According to embodiments of the present invention, at step S303 the similarity between the user and an associated friend at any level of the message sender may be calculated.

It is to be understood that users associated with the message sender are also members of the information interactive system. Hence, for these associated users, matching degrees of each of them with one or more predetermined message categories are stored. In this manner, the similarity between the user and each of one or more associated users may be calculated at step S303 in the way as described at step S302. The detailed procedure is not detailed here.

Next, similarities S2 between the target user and all associated users being considered may be calculated. According to some embodiments, the similarity S2 may be a sum of similarities between the target user and all associated users of the message sender. Alternatively, S2 may also be an average value of these similarities. In these embodiments, different associated users may have different weights. For example, a weight may depend on the number of association levels between an associated user and the message sender; the smaller the number of association level, the larger the weight. In addition, weights may be relevant to an attribute of an associated user in the information interactive system. For example, an associated user who has more friends or is followed in a higher degree may have a larger weight. Note these weights are merely exemplary, and the scope of the present invention is not limited in this regard.

The method 300 then proceeds to step S304 where whether to filter the incoming message is determined.

According to embodiments of the present invention, the determining at step S304 includes determining whether to filter the incoming message, according to the matching degree of the target user with the at least one category determined at step S301, to which content of the incoming message belongs. Specifically, the category to which content of the incoming message belongs is determined at step S301. As described above, by executing the training process of the method 200, matching degrees of the user with one or more message categories are calculated and stored in advance. Thus, the matching degree of the user with the at least one category to which content of the incoming message belongs may be determined.

If an average matching degree or a total matching degree of the user with the categories of the incoming message exceeds a predetermined threshold, it indicates that the user might be interested in the incoming message. Accordingly, the incoming message may be provided to the user for display. On the contrary, if the average matching degree or the total matching degree of the user with the categories of the incoming message is less than the predetermined threshold, it indicates that the user might not be interested in the incoming message. Accordingly, the incoming message may be filtered, thereby avoiding being displayed to the user.

Where optional step S302 is executed, the determining at step S304 may further comprise determining whether to filter the incoming message, according to the similarity S1 between the user and the sender of the incoming message. Specifically, if the similarity S1 between the user and the sender exceeds a predetermined threshold, it indicates that the user might be interested in a message published by the sender. Accordingly, the incoming message may be provided to the user for display. On the contrary, if the similarity S1 between the user and the sender of the incoming message is less than the predetermined threshold, it indicates that the user might not be interested in a message published by the sender. Accordingly, the incoming message may be filtered, thereby avoiding displaying to the user.

Moreover, as described above, optional step S303 may be executed to determine the similarity between the user and the associated user of the message sender. In these embodiments, the determining at step S304 may further comprise determining whether to filter the incoming message, according to the similarity S2 between the user and the associated user of the sender of the incoming message. Specifically, where both steps S302 and S303 are performed, the similarities S2 and S1 may be combined by, for example, adding or averaging them, and then the combined similarity is compared with a predetermined threshold to decide whether to filter the incoming message.

Note steps S302 and S303 are optional, and when both of them are executed, their order of execution may be reversed. In fact, for any received incoming message, one or more of steps S301-S303 may be executed together with step S304 of the method 300 so as to filter the incoming message.

According to embodiments of the present invention, additionally, the filtered message may be deleted directly or go through other appropriate processing. For example, it is possible to delay providing the filtered incoming message to the user. In other words, a message with a larger similarity than a threshold is pushed to the user in real time, while a message with a less similarity than the threshold is pushed to the user after being delayed for a predetermined period of time. Furthermore, the time of delay may be determined according to various factors, such as the user's busy degree, the similarity degree of the incoming message, etc. As an example, in some embodiments, incoming messages may be ranked according to their similarities (S1 and/or S2), and one with a higher rank is delivered to the user at an earlier time.

Alternatively or additionally, the filtered message may be abstracted, and the message abstract displayed to the user, thereby restricting a screen area and/or time taken by these messages. There are already various methods for abstracting a message in the art, and these methods can be used in conjunction with embodiments of the present invention. The scope of the present invention is not limited in this regard. In addition, different display times of messages may be determined based on the size of the similarity S1 and/or S2. Moreover, an outline of message category scores, other statistical information or any other relevant information may be displayed while displaying the incoming message to the user.

The method 300 ends after step S304.

In the methods that have been described with reference to FIGS. 2 and 3, the message may be a microblog or any other message that can be delivered between users by means of the network. The scope of the present invention is not limited in this regard.

FIG. 4 shows a block diagram of a message processing system according to one exemplary embodiment of the present invention.

As shown, according to embodiments of the present invention, the message processing system 400 comprises: a preference determining module 401 configured to determine the preference of a user for at least one message according to actions of the user regarding the message; a category determining module 402 configured to determine at least one category to which content of the message belongs; and a matching degree determining module 403 configured to determine a matching degree between the user and the at least one category according to the preference for filtering further incoming messages.

According to some embodiments of the present invention, actions of the user regarding at least one message comprises at least one of: the user creating the message; the user browsing the message; the user forwarding the message; the user collecting the message; the user clicking on an item representing the message; and the user deleting the message.

According to some embodiments of the present invention, actions of the user regarding at least one message comprises the user browsing the message, and the preference determining module 401 may comprise: a browsing time estimating module configured to estimate a time duration for which the user browses the message; and first preference determining module configured to determine preference of the user for the message according to the estimated time duration.

According to some embodiments of the present invention, the category determining module 402 may comprise: a keyword extracting module configured to extract at least one keyword from content of the message; and a first category determining module configured to determine the at least one category to which content of the message belongs according to whether there is a mapping between the keyword and the category.

According to some embodiments of the present invention, the system 400 may further comprise: a message filtering module configured to filter another received incoming message according to the matching degree.

According to some embodiments of the present invention, the message filtering module includes: a second category determining module configured to determine at least one category to which content of the received further incoming message belongs; and a first filtering decision module configured to decide whether to filter the further incoming message according to a matching degree between the user and the at least one category to which content of the further incoming message belongs.

According to some embodiments of the present invention, the message filtering module includes: a first similarity determining module configured to calculate the similarity between the user and a sender of a received further incoming message according to the matching degree between the user and the at least one message category and to a matching degree between the sender and the at least one message category; and a second filtering decision module configured to decide whether to filter the further incoming message, according to the similarity between the user and the sender.

According to some embodiments of the present invention, the message filtering module includes: a second similarity determining module configured to calculate a similarity between the user and at least one associated user of the sender of the received further incoming message according to the matching degree between the user and the at least one message category and a matching degree between the associated user and the at least one message category; and a third filtering decision module configured to decide whether to filter the further incoming message, according to the similarity between the user and the associated user.

According to some embodiments of the present invention, the system 400 may further includes at least one of: a message deleting module configured to delete the further incoming message where the further incoming message is filtered; a message delaying module configured to delay displaying the further incoming message to the user where the further incoming message is filtered; and a message abstracting module configured to display an abstract of the further incoming message to the user where the further incoming message is filtered.

According to some embodiments of the present invention, the at least one message and the further incoming message that have been described above include a microblog.

It is to be understood that the module and optional sub-module of the system 400 that has been described above with reference to FIG. 4 respectively correspond to the steps of methods 200 and 300 that have been described above with reference to FIGS. 2 and 3. Hence, all features and operations described above with respect to the methods 200 and 300 are also applicable to the system 400, which are not detailed here.

In particular, the division of the module and optional sub-module of the system 400 is not limiting but exemplary. For example, the function of a single module shown in FIG. 4 may be performed by a plurality of modules. Conversely, a plurality of modules shown in this figure may be implemented by a single module. The scope of the present invention is not limited in this regard.

It is to be further understood that the module and sub-module comprised in the system 400 may be implemented in various forms, including software, hardware, firmware or any combination thereof. For example, in some embodiments each module of the system 400 may be implemented using software and/or firmware modules. Alternatively or additionally, the module of the system 400 may be implemented using hardware modules. For example, each module of the system 400 may be implemented as an integrated circuit (IC) chip or application-specific integrated circuit (ASIC). Each module of the system 400 may also be implemented as a system on chip (SOC). Other forms that are currently known or to be developed in future are also feasible. The scope of the present invention is not limited in this regard.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A message processing method, comprising:
determining a preference of a user for at least one message according to an action of the user regarding the at least one message;
determining at least one category to which content of the at least one message belongs; and
determining a matching degree between the user and the at least one category for filtering a further incoming message, based on the preference.

2. The method according to claim 1, wherein the action of the user regarding the at least one message comprises at least one of:
the user creating the at least one message;
the user browsing the at least one message;
the user forwarding the at least one message;
the user collecting the at least one message;
the user clicking on an item representing the at least one message; and
the user deleting the at least one message.

3. The method according to claim 2, wherein the determining a preference of a user for at least one message according to an action of the user regarding the at least one message comprises:
estimating a time duration for which the user browses the at least one message; and
determining the preference of the user for the at least one message according to the estimated time duration.

4. The method according to claim 1, wherein the determining at least one category to which content of the at least one message belongs comprises:
extracting at least one keyword from the content of the at least one message; and
determining the at least one category to which content of the at least one message belongs according to whether there is a mapping between the keyword and the at least one category.

5. The method according to claim 1, further comprising filtering a received further incoming message according to the matching degree.

6. The method according to claim 5, wherein the filtering a received further incoming message according to the matching degree comprises:
determining at least one category to which content of the received further incoming message belongs; and
determining whether to filter the further incoming message according to a matching degree between the user and the at least one category to which content of the further incoming message belongs.

7. The method according to claim 5, wherein the filtering a received further incoming message according to the matching degree comprises:
calculating a similarity between the user and a sender of the received further incoming message according to a matching degree between the user and a predetermined category and to a matching degree between the sender and the predetermined category; and
determining whether to filter the further incoming message according to the similarity between the user and the sender.

8. The method according to claim 5, wherein the filtering a received further incoming message according to the matching degree comprises:
calculating a similarity between the user and at least one associated user of a sender of the received further incoming message according to the matching degree between the user and a predetermined category and to a matching degree between the associated user and the predetermined category; and
determining whether to filter the further incoming message according to the similarity between the user and the associated user.

9. The method according to claim 5, further comprising:
performing at least one of deleting the further incoming message, delaying a display of the further incoming message to the user, and displaying an abstract of the further incoming message to the user if the further incoming message is filtered.

10. A message processing system, comprising:
a preference determining module configured to determine a preference of a user for at least one message according to an action of the user regarding the at least one message;
a category determining module configured to determine at least one category to which content of the at least one message belongs; and
a matching degree determining module configured to determine, based on the preference, a matching degree between the user and the at least one category for filtering a further incoming message.

11. The system according to claim 10, wherein the action of the user regarding the at least one message comprises at least one of:
the user creating the at least one message;
the user browsing the at least one message;
the user forwarding the at least one message;
the user collecting the at least one message;
the user clicking on an item representing the at least one message; and
the user deleting the at least one message.

12. The system according to claim 10, wherein the action of the user regarding the at least one message comprises the user browsing the at least one message, and wherein the preference determining module comprises:
a browsing time estimating module configured to estimate a time duration for which the user browses the at least one message; and
a first preference determining module configured to determine the preference of the user for the at least one message according to the estimated time duration.

13. The system according to claim 10, wherein the category determining module comprises:
a keyword extracting module configured to extract at least one keyword from the content of the at least one message; and
a first category determining module configured to determine the at least one category to which the content of the at least one message belongs according to whether there is a mapping between the keyword and the at least one category.

14. The system according to claim 10, further comprising a message filtering module configured to filter a received further incoming message according to the matching degree.

15. The system according to claim 14, wherein the message filtering module comprises:
a second category determining module configured to determine at least one category to which content of the received further incoming message belongs; and
a first filtering decision module configured to decide whether to filter the further incoming message according to a matching degree between the user and the at least one category to which content of the further incoming message belongs.

16. The system according to claim 14, wherein the message filtering module comprises:
a first similarity determining module configured to calculate a similarity between the user and a sender of the received further incoming message according to a matching degree between the user and a predetermined category and to a matching degree between the sender and the predetermined category; and
a second filtering decision module configured to decide whether to filter the further incoming message according to the similarity between the user and the sender.

17. The system according to claim 14, wherein the message filtering module comprises:
a second similarity determining module configured to calculate a similarity between the user and at least one associated user of a sender of the received further incoming message according to the matching degree between the user and a predetermined category and a matching degree between the associated user and the predetermined category; and
a third filtering decision module configured to decide whether to filter the further incoming message according to the similarity between the user and the associated user.

18. The system according to claim 14, further comprising at least one of:
a message deleting module configured to delete the further incoming message if the further incoming message is filtered;
a message delaying module configured to delay a display of the further incoming message to the user if the further incoming message is filtered; and
a message abstracting module configured to display an abstract of the further incoming message to the user if the further incoming message is filtered.

19. A non-transitory computer readable article of manufacture tangibly embodying computer readable instructions which, when executed, cause a computer to carry out the steps of a method comprising:
determining a preference of a user for at least one message according to an action of the user regarding the at least one message;
determining at least one category to which content of the at least one message belongs; and
determining a matching degree, based on the preference, between the user and the at least one category for filtering a further incoming message.
